(19) United States
(12) Patent Application Publication
(10) Pub. No.: US 2015/0180026 A1
(43) Pub. Date: Jun. 25, 2015

(54) POSITIVE ELECTRODE ACTIVE MATERIAL FOR NON-AQUEOUS ELECTROLYTE SECONDARY BATTERY AND METHOD FOR PRODUCING THE SAME

(71) Applicant: Nichia Corporation, Anan-shi (JP)

(72) Inventor: Kosuke SHIMOKITA, Itano-gun (JP)

(73) Assignee: Nichia Corporation

(21) Appl. No.: 14/581,378

(22) Filed: Dec. 23, 2014

(30) Foreign Application Priority Data
Dec. 24, 2013 (JP) 2013-264795
Dec. 16, 2014 (JP) 2014-253989

(51) Int. Cl. H01M 4/36; H01M 4/1391; H01M 10/05; H01M 4/525; H01M 4/04

(52) U.S. Cl. CPC H01M 4/366; H01M 4/525; H01M 4/0471; H01M 4/0402; H01M 10/05; H01M 4/1391

(57) ABSTRACT

A positive electrode active material for a non-aqueous electrolyte secondary battery, the positive electrode active material including: core particles containing a lithium-transition metal composite oxide represented by the formula: LiₐNi_{1-x-y}CoₓM¹_{y}M²_{z}O₂, wherein a, x, y, and z satisfy the respective relationships: 1.00≦a≦1.50, 0.00≦x≦0.50, 0.00≦y≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo; and a coating layer formed over at least a portion of the surface of the core particles, the coating layer contains magnesium, phosphorus, and oxygen, wherein the coating layer is obtained by individually supplying a first solution containing a magnesium salt of an organic acid and a second solution containing phosphorus and oxygen to the surface of the core particles and subjecting the resultant particles to heat treatment.

### CROSS-REFERENCE TO RELATED APPLICATIONS

This application claims priority under 35 USC 119 from Japanese patent Application No. 2013-264795, filed on Dec. 24, 2013 and Japanese patent Application No. 2014-253989, filed on Dec. 16, 2014, the disclosures of which are incorporated by reference herein.

### BACKGROUND OF THE INVENTION

1. Field of the Invention

The present disclosure relates to a positive electrode active material for a non-aqueous electrolyte secondary battery, such as a lithium-ion secondary battery.

2. Description of Related Art

In recent years, mobile electric devices, such as VTRs, cell phones, and laptop personal computers, have spread and are miniaturized, and, as a power source for the mobile device, a non-aqueous electrolyte secondary battery, such as a lithium-ion secondary battery, is used. Further, recently, environmental problems must be dealt with and therefore, the non-aqueous electrolyte secondary battery is attracting attention as a power battery for, e.g., an electric vehicle.

As a positive electrode active material for a lithium secondary battery, a lithium-cobalt composite oxide is generally widely employed, wherein the lithium-cobalt composite oxide is able to constitute a secondary battery at a level of 4 V.

Cobalt, which is a raw material for a lithium-cobalt composite oxide, is a resource that is scarce and unevenly distributed, and therefore the lithium-cobalt composite oxide as a positive electrode active material has disadvantages not only in that the cost tends to increase, but also in that the supply of the raw material for the active material is likely to be unstable. For removing such disadvantages, a lithium-transition metal composite oxide having a layer structure, such as a lithium-nickel-cobalt-manganese composite oxide, which is obtained from LiCoO₂ by replacing Co in the LiCoO₂ by another element, such as Ni or Mn, has been developed.

In accordance with various purposes in relation to the above, a technique for obtaining a lithium-transition metal composite oxide having in the surface thereof contained a specific element has been known.

Japanese Patent Publication No. 2009-054583 proposes a technique in which a coating layer comprising an element M, such as magnesium, and an element X, such as phosphorus, is formed on the surface of composite oxide particles so that the distributions of the element M and element X in the coating layer are different from each other to obtain a positive electrode active material which exhibits excellent charge/discharge cycle characteristics and a high capacity and which suppresses gas generation. Specifically, an example is disclosed in which composite oxide particles of a lithium-cobalt type composite oxide and a mixture of lithium carbonate, magnesium carbonate, and ammonium dihydrogenphosphate are mixed together so that the surface of the composite oxide particles is mechanochemically coated with the mixture, followed by calcination at 900° C.

Japanese Patent Publication No. 2012-038534 proposes a technique in which a coating layer comprising a phosphoric acid compound and an oxide of, for example, magnesium is formed on the surface of a composite oxide comprising manganese as an essential component and having a layer structure, wherein the coating layer has controlled phosphorus concentration distribution, to obtain a positive electrode material which has improved heat stability in the charged state. Specifically, an example is disclosed in which a composite oxide represented by LiMn_{0.4}(Li_{0.04}Ni_{0.25}Co_{0.25}Al_{0.06})O₂ is added to a mixed solution of magnesium nitrate and lithium hydroxide to deposit a magnesium compound on the surface of the composite oxide, and then a mixed solution of diammonium hydrogenphosphate and lithium hydroxide is added to the resultant mixture to further deposit a phosphoric acid compound, followed by calcination at 650° C.

International Patent Application Publication WO2006/123572 proposes a technique in which phosphorus as a coating element and, for example, magnesium are contained in the surface of a lithium composite oxide, achieving a high capacity and improved stability or low temperature properties. Specifically, an example is disclosed in which a lithium composite oxide represented by Li_{1.03}Co_{0.98}Al_{0.01}Mg_{0.01}O₂ is added to an aqueous solution of magnesium nitrate, and, while stirring, to the resultant mixture is added dropwise an aqueous solution of diammonium hydrogenphosphate, and the resultant solid-liquid mixture is dried and subjected to heat treatment to form a surface layer.

### SUMMARY OF THE INVENTION

The present disclosure provides a positive electrode active material for a non-aqueous electrolyte secondary battery, and the positive electrode active material includes:

a core particle containing a lithium-transition metal composite oxide represented by the formula:

LiₐNi_{1-x-y}COₓM¹_{y}M²_{z}O₂

wherein a, x, y, and z satisfy the respective relationships: 1.00≦a≦1.50, 0.00≦x≦0.50, 0.00≦y≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo; and

a coating layer formed over at least a portion of the surface of the core particle, the coating layer containing magnesium, phosphorus, and oxygen;

wherein the coating layer is obtained by individually supplying a first solution containing a magnesium salt of an organic acid and a second solution containing phosphorus and oxygen to the surface of the core particle and subjecting the resultant particle to heat treatment.

The positive electrode active material enables to obtain a non-aqueous electrolyte secondary battery having improved cycle characteristics at a high voltage.

### BRIEF DESCRIPTION OF THE DRAWINGS

FIG. 1A is a scanning electron microscope image of the positive electrode active material in Example 1.

FIG. 1B is an electron probe micro analysis (EPMA) image showing the distribution of magnesium element with respect to the surface of the positive electrode active material in Example 1.

FIG. 1C is an electron probe micro analysis image showing the distribution of phosphorus element with respect to the surface of the positive electrode active material in Example 1.

FIG. 2A is a scanning electron microscope image of the positive electrode active material in Comparative Example 3.

FIG. 2B is an electron probe micro analysis image showing the distribution of magnesium element with respect to the surface of the positive electrode active material in Comparative Example 3.

FIG. 2C is an electron probe micro analysis image showing the distribution of phosphorus element with respect to the surface of the positive electrode active material in Comparative Example 3.

### DETAILED DESCRIPTION OF EMBODIMENTS

For meeting the recent demand for a secondary battery having an increased energy density, there is a method of increasing the charge voltage of a secondary battery. However, when the charge voltage is increased to a voltage as high as about 4.4 V or more, the lithium-transition metal composite oxide having a layer structure is likely to suffer an irreversible change in the crystal structure. For this reason, the cycle characteristics of the battery tend to be poor. This tendency is marked particularly in the lithium-transition metal composite oxide of a lithium-nickel type composite oxide.

In conventional techniques, when a lithium-transition metal composite oxide of a lithium-nickel type composite oxide is used as a positive electrode active material, the cycle characteristics at a high voltage have not been satisfactorily improved.

In view of the above, the present embodiment has been made. An object of the present embodiment is to provide a positive electrode active material of a lithium-nickel type composite oxide which enables a non-aqueous electrolyte secondary battery to have improved cycle characteristics at a high voltage.

For achieving the above object, the present inventor has conducted extensive and intensive studies, and the present invention has been completed. The present inventor has found that when core particles including a lithium-transition metal composite oxide of a lithium-nickel type composite oxide have in the surface thereof contained magnesium, phosphorus, and oxygen in a specific state, the cycle characteristics at a high voltage are improved.

A positive electrode active material for a non-aqueous electrolyte secondary battery of the present embodiment includes: core particles containing a lithium-transition metal composite oxide represented by the formula: LiₐNi_{1-x-y}CoₓM¹_{y}M²_{z}O₂, wherein a, x, y, and z satisfy the respective relationships: 1.00≦a≦1.50, 0.00≦x≦0.50, 0.00≦y≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo; and a coating layer formed over at least a portion of the surface of the core particle and the coating layer contains magnesium, phosphorus, and oxygen, wherein the coating layer is obtained by individually supplying a first solution containing a magnesium salt of an organic acid and a second solution containing phosphorus and oxygen to the surface of the core particle and subjecting the resultant particle to heat treatment.

A method of the present embodiment for producing a positive electrode active material for a non-aqueous electrolyte secondary battery includes stirring core particles containing a lithium-transition metal composite oxide represented by the formula: LiₐNi_{1-x-y}CoₓM¹_{y}M²_{z}O₂, wherein a, x, y, and z satisfy the respective relationships: 1.00≦a≦1.50, 0.00≦x≦0.50, 0.00≦y≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo; mixing the core particles, as they are stirred, with individual solutions of a first solution containing a magnesium salt of an organic acid, and a second solution containing phosphorus and oxygen to obtain coated core particles, and subjecting the coated core particles to heat treatment.

The positive electrode active material of the present embodiment has the above-mentioned characteristic feature, and therefore it is possible to obtain a non-aqueous electrolyte secondary battery having improved cycle characteristics at a high voltage. The method of the present embodiment has the above-mentioned characteristic feature, and therefore a positive electrode active material, which makes it possible to obtain a non-aqueous electrolyte secondary battery having improved cycle characteristics at a high voltage, can be efficiently produced.

In the present specification, the term “step” includes not only an independent step but also a step which can achieve the desired object of the step even through the step cannot be clearly distinguished from the other steps. With respect to the content of the component in the composition, when a plurality of substances corresponding to the components of the composition are present in the composition, the content means a total amount of the plurality of substances present in the composition unless otherwise specified.

Hereinbelow, the positive electrode active material of the present embodiment will be described in detail with reference to the following embodiments and Examples, which should not be construed as limiting the scope of the present invention.

[Positive Electrode Active Material]

The positive electrode active material for a non-aqueous electrolyte secondary battery of the present embodiment includes: core particles containing a lithium-transition metal composite oxide represented by the compositional formula: LiₐNi_{1-x-y}CoₓM¹_{y}M²_{z}O₂; and a coating layer formed over at least a portion of the surface of the core particle and the coating layer includes a heat treatment product containing magnesium, phosphorus, and oxygen, wherein the coating layer is obtained by individually supplying a first solution containing a magnesium salt of an organic acid and a second solution containing phosphorus and oxygen to the surface of the core particle and subjecting the resultant particle to heat treatment. In the formula above, a, x, y, and z satisfy the respective relationships: 1.00≦a≦1.50, 0.00≦x≦0.50, 0.00≦y≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo.

[Core Particles]

The core particles include a lithium-transition metal composite oxide (of a lithium-nickel type composite oxide) containing nickel as an essential component. A part of the nickel site may be replaced by, for example, cobalt, manganese, or aluminum. The core particles may further contain another element.

When replacing a part of the nickel site by cobalt, the replacement amount is 50 mol % or less of the nickel. When the replacement amount for nickel is small, the cost of the production can be advantageously suppressed. Taking the balance between various properties into consideration, a preferred replacement amount for nickel is from 5 to 35 mol %.

When replacing a part of the nickel site by at least one element M¹ selected from the group consisting of manganese and aluminum, the total replacement amount by element M¹ is 50 mol % or less of the nickel. When the total replacement amount is 50 mol % or less, it is likely that more excellent output characteristics and charge-discharge capacity can be obtained. When the nickel amount in the nickel site is too small, the charge-discharge capacity tends to be reduced, and therefore the total replacement amount for the nickel site is 70 mol % or less. Taking the balance between various properties into consideration, the total replacement amount for the nickel site is preferably from 20 to 60 mol %. The total replacement amount for the nickel site means the total of the replacement amount by cobalt and the replacement amount by element M¹.

As examples of other elements which can be further contained in the composition of the core particles, there can be mentioned zirconium (Zr), tungsten (W), titanium (Ti), magnesium (Mg), tantalum (Ta), niobium (Nb), and molybdenum (Mo), and at least one element M² selected from the group consisting of these elements can be preferably selected. When the amount of the element M² contained is 2 mol % or less, the various objects aimed at by the respective elements M² can be achieved without inhibiting the improvements of properties by the other elements. For example, zirconium advantageously further improves the storage properties, titanium and magnesium advantageously further improve the cycle characteristics, and vanadium advantageously further improves the safety.

When the amount of the lithium contained in the composition of the core particles is large, it is likely that the output characteristics are improved. However, the particles containing lithium in too large an amount tend to be difficult to synthesize. Even if such particles can be synthesized, the particles are likely to have suffered excessive sintering, making the subsequent handling of them difficult. From the above viewpoints, the amount of the lithium contained is 100 to 150 mol %, based on the mole of the element in the nickel site. Taking into consideration, for example, the balance between the properties and ease of the synthesis, the amount of the lithium contained is preferably 105 to 125 mol %.

Thus, the core particles in the positive electrode active material of the present embodiment are represented by the compositional formula: LiₐNi_{1-x-y}CoₓM¹_{y}M²_{z}O₂, wherein a, x, y, and z satisfy the respective relationships: 1.00≦a≦1.50, 0.00≦x≦0.50, 0.00≦y≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo.

With respect to the core particles merely having the above-mentioned composition, it is noted that, when the charge voltage is around 4.4 V or more, the particles are likely to suffer an irreversible change in the crystal structure to cause dissolution of the transition metal, so that, for example, the electrolyte in the electrolytic solution suffers decomposition, leading to the deterioration of cycle characteristics. Therefore, it is necessary that the core particles be provided with the coating layer described below.

[Coating Layer]

The coating layer is formed over at least a portion of the surface of the core particle, and includes a heat treatment product containing magnesium, phosphorus, and oxygen. The elements in the coating layer are presumed to be present mainly in the form of magnesium orthophosphate, but can be in other various forms, such as a form of a metaphosphate, a form of a monohydrogenmetaphosphate, and a form of a double salt with a part of the elements constituting the core particles. For this reason, it is difficult to specify the state of the coating layer only by a chemical analysis. By using, for example, an electron probe micro analysis (e.g., EPMA or SEM-EDX), X-ray photoelectron spectroscopy (XPS), or Auger electron spectroscopy, it is possible to specify and compare the state of the coating layer. It is considered that the coating layer prevents the core particles from suffering an irreversible change in the crystal structure, thus preventing dissolution of the transition metal from the core particles. The coating layer may either cover the entire surface of the core particles, or be disposed in only a part of the region of the surface of the core particles so that a part of the surface of the core particles is exposed.

With respect to the amount of each of magnesium and phosphorus contained in the coating layer, when the amount is too small relative to the core particles, a satisfactory effect cannot be obtained, and, when the amount is too large, the output characteristics or charge-discharge capacity may be lowered. Therefore, it is preferred that the respective amounts of magnesium and phosphorus are appropriately controlled. The magnesium is preferably contained in an amount of 0.75 mol % or less, more preferably 0.10 to 0.50 mol %, based on the mole of the lithium-transition metal composite oxide as the core particles. The phosphorus is preferably contained in an amount of 0.75 mol % or less, more preferably 0.10 to 0.5 mol %, based on the mole of the lithium-transition metal composite oxide as the core particles.

The coating layer is in a form obtained by individually supplying a first solution containing a magnesium salt of an organic acid and a second solution containing phosphorus and oxygen to the surface of the core particles and subjecting to heat treatment the resultant coated core particles having deposited on the surface thereof the first solution and second solution or a reaction product formed from these solutions. That is, the coating layer in the positive electrode active material is in a form of a coating layer which has been heat-treated and includes a heat treatment product containing magnesium, phosphorus, and oxygen. Details have not been elucidated, but it seems that the forms of the magnesium and phosphorus and optionally the elements constituting the core particles in the coating layer affect the effects of the present embodiment. The coating layer is preferably in a form obtained by the method described below. Further, it is more preferred that each of the first solution and the second solution does not contain the elements constituting the core particles. When the element constituting the core particles is present in the coating layer, mainly the element in a form derived from the core particles is considered to affect the effects of the present embodiment. The details of this are described later.

[Method for Producing the Positive Electrode Active Material]

As a preferred method for producing the positive electrode active material, the method of the present embodiment is described. By the method of the present embodiment, a coating layer in a preferred form can be obtained on the surface of the core particles. The method of the present embodiment includes the steps of: stirring core particles containing a lithium-transition metal composite oxide represented by the formula: LiₐNi_{1-x-y}CoₓM¹_{y}M²_{z}O₂, wherein a, x, y, and z satisfy the respective relationships: 1.00≦a≦1.50, 0.00≦x≦0.50, 0.00≦y≦≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo; mixing the core particles, as they are stirred, with individual solutions of a first solution containing a magnesium salt of an organic acid, and a second solution containing phosphorus and oxygen and mixing them with one another to obtain coated core particles (mixing step); and subjecting the coated core particles to heat treatment to obtain a positive electrode active material (heat treatment step). The method may further include providing core particles (provision step).

<Provision Step>

The core particles including a lithium-transition metal composite oxide represented by the above-shown compositional formula may be provided by producing a lithium-transition metal composite oxide using a known method, or may be provided by obtaining a lithium-transition metal composite oxide already produced. A known method includes obtaining a raw material mixture by, for example, a method in which raw material compounds capable of decomposing into an oxide at a high temperature are mixed according to the intended formulation, or a method in which raw material compounds soluble in a solvent are dissolved in the solvent, and precipitation of a precursor is caused in the resultant solution by, for example, controlling the temperature or pH of the solution or adding a complexing agent to the solution; and calcining the obtained raw material mixture at an appropriate temperature (for example, 700 to 1,100° C.). With respect to the sintered material obtained after calcination, when an unreacted substance and others are preliminarily removed by, e.g., washing with water, the resultant coating layer is in a more preferred form. The provided lithium-transition metal composite oxide may be further subjected to pulverization treatment or classification treatment. With respect to the particle diameter of the provided core particles, there is no particular limitation, and the particle diameter may be appropriately selected according to, for example, the purpose. The particle diameter of the core particles can be, for example, 3 to 20 μm.

<Mixing Step>

In the mixing step, for example, the provided core particles are stirred using an appropriate stirring apparatus, and a first solution containing a magnesium salt of an organic acid and a second solution containing phosphorus and oxygen are individually added to the core particles being stirred, and they are mixed with one another to obtain coated core particles having deposited on the surface thereof the first solution and second solution or a reaction product formed from these solutions. With respect to the method for adding the solution, there is no particular limitation, and the method may be selected from methods generally used (for example, dropwise adding the solution, or continuously adding the solution by a small portion). The first solution and second solution may be individually and independently added, and it is preferred that the additions of the first solution and second solution temporally overlap. With respect to the method for stirring the core particles, there is no particular limitation, and the core particles may be stirred using a stirring apparatus appropriately selected from stirring apparatuses generally used. Examples of solvents for the first solution and second solution include water and a lower alcohol, and the solvent may be appropriately selected according to the solute used and other purposes. Thus, magnesium, phosphorus, and oxygen are permitted to be present on the surface of the core particles in a so-called semiwet process such that the fluidity of the core particles is maintained, and then the resultant core particles are subjected to the subsequent heat treatment step, so that the obtained coating layer is in an especially preferred form.

The total amount of the first solution and second solution added relative to the weight of the core particles is a certain amount or less so that the mixing step becomes of a semiwet process. When the mixing step is of a semiwet process, it is likely that the coating layer in a more preferred form is formed. The total amount of the first solution and second solution added is preferably 20% by weight or less, based on the weight of the core particles. The lower limit of the total amount is not particularly limited. However, from the viewpoint of preventing the coating layer from being present unevenly, the total amount is practically, for example, 1% by weight or more. The total amount of the first solution and second solution added is more preferably 5 to 15% by weight, based on the weight of the core particles. Taking the above into consideration, the concentrations of the first solution and second solution may be appropriately selected.

When the first solution is a solution of a magnesium salt of an organic acid, it is easy to remove anion-derived impurities in the heat treatment step. Examples of organic acid magnesium salts include magnesium oxalate, magnesium acetate, magnesium formate, magnesium benzoate, and magnesium citrate, and preferred is at least one member selected from the group consisting of these magnesium salts. Of these, more preferred is at least one member selected from the group consisting of magnesium acetate, magnesium formate, and magnesium benzoate because these salts have a relatively high solubility in water. Especially preferred is magnesium acetate because it has a high solubility in water and is relatively easily available and handled. With respect to the organic acid magnesium salt contained in the first solution, the above magnesium slats may be used individually or in combination.

The second solution contains at least phosphorus and oxygen, preferably contains a phosphorus compound including phosphorus and oxygen, more preferably contains phosphoric acid or a salt thereof, especially preferably contains an ammonium salt or amine salt of phosphoric acid. When the second solution is a solution of an ammonium salt or amine salt of phosphoric acid, it is advantageously easy to remove cation-derived impurities in the heat treatment step. When a specific cation is intentionally added, the specific cation salt of phosphoric acid can be used. As an ammonium salt of phosphoric acid, specifically, for example, diammonium monohydrogenphosphate or ammonium dihydrogenphosphate can be appropriately selected. The phosphorus compounds may be used individually or in combination.

It is preferred that the second solution is weakly basic for promoting the reaction between magnesium ions contained in the first solution and phosphoric acid ions in the second solution. Specifically, the pH of the second solution is preferably about 7.3 to 8.4. The pH adjustment is preferably performed using mainly a basic compound containing no metal, such as ammonia or an amine.

When the second solution includes phosphoric acid, the phosphoric acid can be selected from various forms, such as orthophosphoric acid (so-called ordinary phosphoric acid), diphosphoric acid (pyrophosphoric acid), metaphosphoric acid, and polyphosphoric acid. Taking into consideration, for example, ease of the preparation of the solution and ease of the handling of the solution, orthophosphoric acid may be selected. In the Examples below, the phosphoric acid is meant to be orthophosphoric acid.

It is preferred that each of the first solution and the second solution substantially does not contain the elements constituting the lithium-transition metal composite oxide contained in the core particles. The term “substantially” means that elements inevitably mixed into the particles are not excluded, and the amount of such elements contained is preferably 0.05% by weight or less. The heat treatment product contained in the coating layer can contain the elements constituting the lithium-transition metal composite oxide contained in the core particles, and these elements are preferably supplied from the core particles in the mixing step and/or heat treatment step, which is considered to produce a form of the coating layer.

<Heat Treatment Step>

In the heat treatment step, the coated core particles obtained in the mixing step are subjected to heat treatment to form a coating layer on the surface of the core particles. The object of the heat treatment step is removal of the liquid phase added in the mixing step, a reaction of magnesium ions with phosphorus and oxygen (preferably, phosphoric acid ions), and optionally a further reaction of the elements constituting the lithium-transition metal composite oxide contained in the core particles with magnesium ions and/or phosphoric acid ions. When the heat treatment temperature is too low, it is likely that the formation of an intended coating layer is unsatisfactory. When the heat treatment temperature is too high, a disadvantage can be caused, for example, in that the elements constituting the lithium-transition metal composite oxide are supplied in an excess amount from the core particles to cause the properties of the core particles to become poor, that magnesium ions are dissolved in the core particles to form a solid as a part of the core particles, causing the properties of the core particles to change, or that the coating layer becomes in an unintended form. Therefore, the heat treatment temperature is appropriately controlled. When the heat treatment temperature is 300 to 550° C., it is easy to form a preferred coating layer.

[Positive Electrode]

The positive electrode for a non-aqueous electrolyte secondary battery of the present embodiment includes, for example, a current collector, and a positive electrode active material layer disposed on the current collector. The positive electrode is in a mode which is substantially the same as that generally used, except that the positive electrode active material of the present embodiment is used. A non-aqueous electrolyte secondary battery including the positive electrode of the present embodiment has improved cycle characteristics at a high voltage.

[Non-Aqueous Electrolyte Secondary Battery]

The non-aqueous electrolyte secondary battery of the present embodiment includes, for example, the positive electrode of the present embodiment, a negative electrode, and a non-aqueous electrolyte, and optionally a separator disposed between the positive electrode and the negative electrode. For example, the negative electrode, non-aqueous electrolyte, and separator used in the present embodiment are in respective modes which are the same as those generally used. The non-aqueous electrolyte secondary battery of the present embodiment has improved cycle characteristics at a high voltage.

### EXAMPLES

Hereinbelow, the present embodiment will be described in more detail with reference to the following Examples, which should not be construed as limiting the present embodiment.

### Example 1

Pure water in a reaction vessel was prepared, and, while stirring, respective aqueous solutions of nickel sulfate, cobalt sulfate, and manganese sulfate were dropwise added to the water in the vessel so that the flow rate ratio between the aqueous solutions (Ni:Co:Mn) became 35:35:30. After completion of the addition of the aqueous solutions, the temperature of the resultant mixture was adjusted to 50° C., and an aqueous sodium hydroxide solution in a predetermined amount was dropwise added to the mixture to obtain a precipitate of a nickel-cobalt-manganese composite hydroxide. The obtained precipitate was washed with water, and subjected to filtration and separation, and mixed with lithium carbonate so that the Li:(Ni+Co+Mn):Zr ratio became 1.10:1:0.005 to obtain a mixed raw material. The obtained mixed raw material was calcined in an air atmosphere at 850° C. for 3 hours, and subsequently calcined at 890° C. for 4 hours to obtain a sintered material. The obtained sintered material was pulverized, and subjected to dry sieving to obtain a lithium-transition metal composite oxide represented by the general formula: Li_{1.10}Ni_{0.5}Co_{0.2}Mn_{0.3}Zr_{0.005}O₂. The obtained lithium-transition metal composite oxide was washed with water and then dried to obtain core particles.

The obtained core particles were stirred using a stirrer, and to the core particles were added dropwise a 20% by weight aqueous magnesium acetate solution as a first solution and, as a second solution, a 10% by weight ammonium dihydrogenphosphate solution having a pH adjusted to 7.8 using aqueous ammonia to obtain coated core particles. The amounts of the first and second solutions added were individually controlled so that the magnesium atom was present in an amount of 0.5 mol % and the phosphorus atom was present in an amount of 0.5 mol %, based on the mole of the lithium-transition metal composite oxide as the core particles. The total amount of the first and second solutions added was 9.5% by weight, based on the weight of the core particles.

The obtained coated core particles were stirred for a while, and then subjected to heat treatment in air at 450° C. for 10 hours to form a coating layer on the core particles, obtaining an intended positive electrode active material.

### Example 2

An intended positive electrode active material was obtained in substantially the same manner as in Example 1 except that the amounts of the first and second solutions added were individually controlled so that the magnesium atom was present in an amount of 0.1 mol % and the phosphorus atom was present in an amount of 0.5 mol %, based on the mole of the lithium-transition metal composite oxide as the core particles.

### Example 3

An intended positive electrode active material was obtained in substantially the same manner as in Example 1 except that the amounts of the first and second solutions added were individually controlled so that the magnesium atom was present in an amount of 0.3 mol % and the phosphorus atom was present in an amount of 0.5 mol %, based on the mole of the lithium-transition metal composite oxide as the core particles.

### Comparative Example 1

The core particles in Example 1, on which a coating layer had not been formed, were used as a positive electrode active material.

### Comparative Example 2

Magnesium phosphate {Mg₃(PO₄)₂} particles were mixed in an amount of 0.25 mol % into the core particles in Example 1 and the resultant mixture was stirred using a blade type mixer to obtain mixed particles. The obtained mixed particles were subjected to heat treatment in air at 450° C. for 10 hours to obtain an intended positive electrode active material.

### Comparative Example 3

An intended positive electrode active material was obtained in substantially the same manner as in Example 1 except that, instead of the 20% by weight aqueous magnesium acetate solution, a 21% by weight aqueous magnesium nitrate solution was used as the first solution.

### Comparative Example 4

An intended positive electrode active material was obtained in substantially the same manner as in Example 1 except that the first aqueous solution was not used.

### Comparative Example 5

An intended positive electrode active material was obtained in substantially the same manner as in Example 1 except that the second aqueous solution was not used.

[Evaluation of the Cycle Characteristics]

Using each of the positive electrode active materials obtained in Examples 1 to 3 and Comparative Examples 1 to 5, a battery for evaluation was prepared in accordance with the procedure described below, and, using the prepared battery, cycle characteristics were measured by the method described below.

[1. Preparation of a Positive Electrode]

85 Parts by weight of a positive electrode composition, 10 parts by weight of acetylene black, and 5.0 parts by weight of PVDF (polyvinylidene fluoride) were dispersed in NMP (N-methyl-2-pyrrolidone) to prepare a positive electrode slurry. The prepared positive electrode slurry was applied to an aluminum foil, and dried and then subjected to compression molding using a roller press, followed by cutting into a predetermined size, to obtain a positive electrode.

[2. Preparation of a Negative Electrode]

97.5 Parts by weight of artificial graphite, 1.5 part by weight of CMC (carboxymethyl cellulose), and 1.0 part by weight of an SBR (styrene-butadiene rubber) were dispersed in water to prepare a negative electrode slurry. The prepared negative electrode slurry was applied to a copper foil, and dried and then subjected to compression molding using a roller press, followed by cutting into a predetermined size, to obtain a negative electrode.

[3. Preparation of a Non-Aqueous Electrolytic Solution]

EC (ethylene carbonate) and MEC (methylethyl carbonate) were mixed in a volume ratio of 3:7 to obtain a mixed solvent. Lithium hexafluorophosphate (LiPF₆) was dissolved in the obtained mixed solvent so that the lithium hexafluorophosphate concentration became 1 mol/1 to obtain a non-aqueous electrolytic solution.

[4. Assembly of a Battery for Evaluation]

Lead electrodes were respectively attached to the current collectors of the above-obtained positive electrode and negative electrode, followed by vacuum drying at 120° C. Then, a separator comprised of porous polyethylene was placed between the positive electrode and the negative electrode, and the resultant material was contained in a laminate packaging container in a bag form. The container containing therein the above material was subjected to vacuum drying at 60° C. to remove moisture adsorbing on the individual members contained. After vacuum drying, the above-prepared non-aqueous electrolytic solution was injected into the laminate packaging container, and the container was sealed to obtain a non-aqueous electrolyte secondary battery for evaluation of a lamination type.

[5. Measurement of a Charge-Discharge Capacity]

The obtained battery was subjected to aging by allowing a weak current to flow through the battery, so that the electrolyte satisfactorily permeated into the positive electrode and negative electrode. After the aging, the resultant battery was placed in a thermostatic chamber set at 45° C. A series of the charging operation at a charge potential of 4.4 V and at a charge current of 2.0 C (wherein 1 C indicates a current at which discharging is completed in 1 hour) and the discharging operation at a discharge potential of 2.75 V and at a discharge current of 2.0 C was taken as 1 cycle, and the cycle of charging and discharging operations was repeatedly performed with respect to the battery. A value obtained by dividing the discharge capacity in the n-th cycle by the discharge capacity in the 1st cycle was determined as a discharge capacity maintaining ratio Rs (n) for the n-th cycle. A higher Rs (n) indicates excellent cycle characteristics.

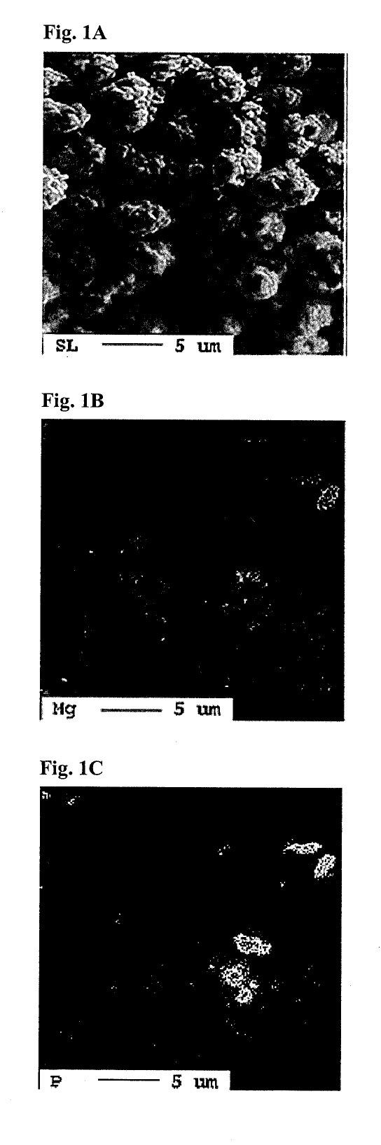

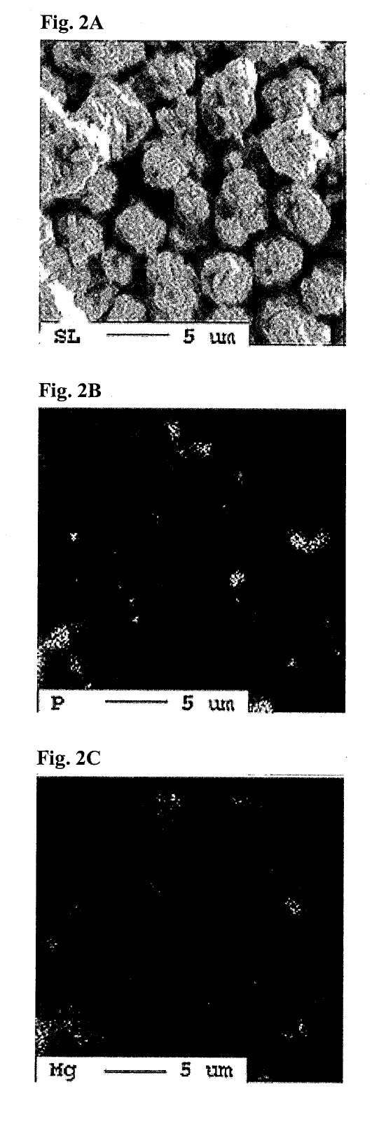

The preparation conditions in Examples 1 to 3 and Comparative Examples 1 to 5 are summarized in Table 1, and the respective molar ratios of the magnesium atom and phosphorus atom contained in the coating layer to the lithium-transition metal composite oxide as the core particles and the discharge capacity maintaining ratio Rs (100) for the 100th cycle are shown in Table 2. In Table 1, the weight ratio of the total of the added first solution and second solution to the core particles is shown as Rsc. Further, with respect to the positive electrode active materials in Example 1 and Comparative Example 3, the distributions of the magnesium element and phosphorus element were measured by an electron probe micro analyzer. SEM Images of the positive electrode active materials are shown in FIGS. 1A and 2A, the distribution of the magnesium element is shown FIGS. 1B and 2B, and the distribution of the phosphorus element is shown FIGS. 1C and 2C.

TABLE 1

| | | First solution | | Second solution | | | Rsc/ | Heat treatment |
|---|---|---|---|---|---|---|---|---|
| | Core particles | Solute | Concentration | Solute | Concentration | pH | wt % | temperature |
| Example 1 | Li_{1.10}Ni_{0.5}Co_{0.2} | Mg(CH₃COO)₂ | 20 wt % | (NH₄)H₂PO₄ | 10 wt % | 7.8 | 9.5 | 450° C. |
| Example 2 | Mn_{0.3}Zr_{0.005}O₂ | | | | | | 6.6 | |
| Example 3 | | | | | | | 8.1 | |
| Comparative | | — | — | — | — | — | — | — |
| example 1 | | | | | | | | |

| Comparative | Mg₃(PO₄)₂(Solid) | | | | | — | 450° C. |
|---|---|---|---|---|---|---|---|
| example 2 | | | | | | | |
| Comparative | Mg(NO₃)₂ | 21 wt % | (NH₄)H₂PO₄ | 10 wt % | 7.8 | 9.5 | 450° C. |
| example 3 | | | | | | | |
| Comparative | — | — | (NH₄)H₂PO₄ | 10 wt % | 7.8 | 5.9 | |
| example 4 | | | | | | | |
| Comparative | Mg(CH₃COO)₂ | 20 wt % | — | — | — | 3.6 | |
| example 5 | | | | | | | |

TABLE 2

| | Element ratio in coating layer | | |
|---|---|---|---|
| | Mg | P | Rs(100)/% |
| Example 1 | 0.5 mol % | 0.5 mol % | 53 |
| Example 2 | 0.1 mol % | 0.5 mol % | 45 |
| Example 3 | 0.3 mol % | 0.5 mol % | 58 |
| Comparative | — | — | 0 |
| example 1 | | | |
| Comparative | 0.75 mol % | 0.5 mol % | 0 |
| example 2 | | | |
| Comparative | 0.5 mol % | 0.5 mol % | 33 |
| example 3 | | | |
| Comparative | 0 | 0.5 mol % | 28 |
| example 4 | | | |
| Comparative | 0.5 mol % | 0 | 0 |
| example 5 | | | |

As is apparent from Tables 1 and 2, in the secondary battery using Comparative Example 1 in which no coating layer is formed or using Comparative Example 5 in which the second solution is not used, the discharge capacity maintaining ratio for the charge-discharge cycle that is repeated 100 times at a high voltage disadvantageously becomes 0%, whereas, in the secondary battery using Examples 1 to 3 in which the coating layer is formed by the method of the present embodiment, the cycle characteristics are dramatically improved. Further, it is apparent that, in the secondary battery using Comparative Example 3 in which the first solution is a solution of a magnesium salt of an inorganic acid or using Comparative Example 4 in which the first solution is not used, the cycle characteristics are unsatisfactory. As is apparent from FIGS. 1A to 1C and 2A to 2C, in Example 1 in which the first solution is a solution of a magnesium salt of an organic acid, the magnesium element and phosphorus element are individually distributed throughout the particles, whereas, in the positive electrode active material in Comparative Example 3 in which the first solution is a solution of a magnesium salt of an inorganic acid, the magnesium element and phosphorus element are individually distributed unevenly.

A non-aqueous electrolyte secondary battery using the positive electrode active material of the present embodiment can be charged and discharged at a high voltage, and therefore can achieve high energy density and excellent battery life. Such a non-aqueous electrolyte secondary battery can be advantageously used as a power source for an electric device which is repeatedly charged and discharged at a high voltage, for example, for an electric vehicle.

As described above, it should be obvious that various other embodiments are possible without departing the spirit and scope of the present invention. Accordingly, the scope and spirit of the present embodiment should be limited only by the following claims.

All publications, patent applications, and technical standards mentioned in this specification are herein incorporated by reference to the same extent as if each individual publication, patent application, or technical standard was specifically and individually indicated to be incorporated by reference.

What is claimed is:

1. A positive electrode active material for a non-aqueous electrolyte secondary battery, the positive electrode active material comprising:
a core particle comprising a lithium-transition metal composite oxide represented by the formula:
LiₐNi_{1-x-y}CoₓM¹_{y}M²_{z}O₂
wherein a, x, y, and z satisfy the respective relationships: 1.00≦a≦1.50, 0.00≦x≦0.50, 0.00≦y≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo; and
a coating layer formed over at least a portion of the surface of the core particle, the coating layer comprising magnesium, phosphorus, and oxygen,
wherein the coating layer is obtained by individually supplying a first solution comprising a magnesium salt of an organic acid and a second solution comprising phosphorus and oxygen to the surface of the core particle and subjecting the resultant particle to heat treatment.

2. The positive electrode active material according to claim 1, wherein the magnesium is present in the coating layer in an amount of 0.75 mol % or less, based on the mole of the lithium-transition metal composite oxide.

3. The positive electrode active material according to claim 1, wherein the phosphorus is present in the coating layer in an amount of 0.75 mol % or less, based on the mole of the lithium-transition metal composite oxide.

4. The positive electrode active material according to claim 2, wherein the phosphorus is present in the coating layer in an amount of 0.75 mol % or less, based on the mole of the lithium-transition metal composite oxide.

5. A method for producing a positive electrode active material for a non-aqueous electrolyte secondary battery, the method comprising:
stirring core particles comprising a lithium-transition metal composite oxide represented by the formula:
LiₐNi_{1-x-y}CoₓM¹_{y}M²_{z}O₂
wherein a, x, y, and z satisfy the respective relationships: 1.00≦a≦1.50, 0.00≦x≦0.50, 0.00≦y≦0.50, 0.00≦z≦0.02, and 0.00≦x+y≦0.70, M¹ represents at least one element selected from the group consisting of Mn and Al, and M² represents at least one element selected from the group consisting of Zr, W, Ti, Mg, Ta, Nb, and Mo;
mixing the core particles, as they are stirred, with individual solutions of a first solution comprising a magnesium salt of an organic acid, and a second solution comprising phosphorus and oxygen to obtain coated core particles; and
subjecting the obtained coated core particles to heat treatment.

6. The method according to claim 5, wherein the total amount of the first solution and second solution added is 1 to 20% by weight, based on the weight of the core particles.

7. The method according to claim 5, wherein the organic acid is acetic acid.

8. The method according to claim 5, wherein the second solution is a solution of an ammonium salt of phosphoric acid.

9. The method according to claim 5, wherein the second solution has a pH of 7.3 to 8.4.

10. The method according to claim 5, wherein the heat treatment for the coated core particles is performed at 300 to 550° C.

11. The method according to claim 7, wherein the second solution is a solution of an ammonium salt of phosphoric acid.

12. The method according to claim 7, wherein the second solution has a pH of 7.3 to 8.4.

13. The method according to claim 7, wherein the heat treatment for the coated core particles is performed at 300 to 550° C.

14. The method according to claim 11, wherein the second solution has a pH of 7.3 to 8.4.

15. The method according to claim 11, wherein the heat treatment for the coated core particles is performed at 300 to 550° C.

16. The method according to claim 14, wherein the heat treatment for the coated core particles is performed at 300 to 550° C.

17. A positive electrode for a non-aqueous electrolyte secondary battery, the positive electrode comprising the positive electrode active material according to claim 1

18. A positive electrode for a non-aqueous electrolyte secondary battery, the positive electrode comprising the positive electrode active material obtained by the method according to claim 5.

19. A non-aqueous electrolyte secondary battery comprising the positive electrode according to claim 17, a negative electrode, and a non-aqueous electrolyte.

20. A non-aqueous electrolyte secondary battery comprising the positive electrode according to claim 18, a negative electrode, and a non-aqueous electrolyte.
